(19) United States
(12) Patent Application Publication
(10) Pub. No.: US 2011/0036333 A1
(43) Pub. Date: Feb. 17, 2011

(54) METHOD FOR CONTROLLING AN ENGINE

(75) Inventors: Laurent Fontvieille, Gif Sur Yvette (FR); Michael Remingol, Ivry Sur Seine (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S, Boulogne Billancourt (FR)

(21) Appl. No.: 12/989,327

(22) PCT Filed: Apr. 21, 2009
(86) PCT No.: PCT/FR2009/050744

§ 371 Date: Oct. 22, 2010

(30) Foreign Application Priority Data
Apr. 29, 2008 (FR) 0852887

(51) Int. Cl. F02B 33/00

(52) U.S. Cl. 123/564

(57) ABSTRACT

A method for controlling an engine that is supercharged by a turbocharger, including calculating a temperature of the gases at the inlet to a compressor of the turbocharger, followed by determining a boost pressure set point, the value of the set point being dependent particularly on the temperature of the gases at the inlet to the compressor calculated in such a way as to set a boost pressure in an inlet manifold of the engine.

The present invention relates to the field of engine control.

More particularly, the invention relates to a method for controlling an engine, which is designed to regulate the boost pressure in an inlet manifold of the engine.

The use of a method of this type is particularly advantageous for diesel engines which are supercharged by one or a plurality of stepped turbocharger(s).

Motor vehicles, and in particular motor vehicles of the diesel type, are very often equipped with a turbocharger to boost the engine with air, which is designed to increase the quantity of air admitted into the cylinders of the engine.

The or each turbocharger comprises a turbine, which is placed at the outlet from the exhaust manifold of the engine, and is driven by the exhaust gases.

In addition, it comprises a compressor which is fitted on the same axis as the turbine, which ensures compression of the air which enters the inlet manifold of the engine.

In this case, the or each turbocharger is associated with a unit to regulate the power of the exhaust gases, which is designed to regulate the pressure which exists in the inlet manifold around a developed boost pressure set-point value.

A regulation unit of this type corresponds for example to blades in the case of a turbocharger with variable geometry, or to discharge valves which are placed at the terminals of the turbine in the case of a turbocharger with fixed geometry.

The action on said regulation unit is controlled by a central unit which can regulate the boost pressure in the inlet manifold, in particular in accordance with measurements of the boost pressure at the inlet to the turbine.

The central unit thus comprises at least one regulator which is responsible for regulating the boost pressure to a boost pressure set point.

In order to improve the response time of this regulation structure, the output of the regulator is added to a pre-positioning value of the regulation unit, in order to provide the latter with a control signal which acts on the pressure of the engine exhaust gases.

Conventionally, the boost pressure set point is mapped, for example according to the engine speed and the engine torque, on the basis of the turbocharger blades, and is corrected in accordance with physical values such as, for example, the post-turbine pressure, the pre-turbine pressure, and the temperature of the air which enters the compressor.

The pre-positioning value of the regulation unit is also provided in the form of mapping, for example in the form of engine speed and engine torque, corrected in accordance with the atmospheric pressure and the temperature of the air which enters the compressor.

Thus, a boost pressure set point corresponds to a point of the pre-positioning mapping of the regulation unit. The pre-positioning will be imparted, with inclusion of the position set-point values of the blades which make it possible to obtain the boost set-point pressure for each point of functioning of the engine.

However, this type of regulation structure remains limited.

In particular, it suffers from a lack of robustness for an engine comprising a low-pressure exhaust gas recirculation circuit.

In fact, in this type of engine, the exhaust gas recirculation circuit which is designed to reduce the quantity of nitric oxides produced by the engine is constituted by putting the exhaust circuit and the inlet circuit into communication.

More specifically, in the case in which a single turbocharger is provided, it is constituted by putting into communication the exhaust circuit after a particle filter, and the inlet circuit before the compressor, via a section of passage with dimensions which are regulated by an exhaust gas recirculation valve. In the case in which stepped turbochargers are provided (low pressure, high pressure), it is constituted by putting into communication the exhaust circuit after a particle filter, and the inlet circuit before the compressor of the low-pressure turbocharger, via a section of passage with dimensions which are regulated by an exhaust gas recirculation valve.

By returning the exhaust gases upstream from the compressor, or, in the case in which two stepped turbochargers are provided, upstream from the low-pressure turbocharger, the temperature which enters the compressor, or low-pressure compressor if applicable, is then a mixture of the temperatures of the flow of cold air and the flow of low-pressure exhaust gas recirculation.

The exhaust gas recirculation circuit affects the boost control in that the temperature of the cold air which enters the compressor, or low-pressure compressor if applicable, plays a part in the determination of the boost pressure set point and the pre-positioning value of the blades.

The temperature of the cold air which enters the compressor, or low-pressure compressor if applicable, is measured at present by a temperature sensor which is placed in a cold air flow meter upstream from the compressor.

However, the difficulty in obtaining a mixture with a homogeneous temperature upstream from the compressor, for correct measurement of the temperature, and the risks of dirtying the sensor associated with the proximity of the gases of the exhaust gas recirculation circuit, do not make it possible to carry out correct temperature measurements.

In addition, using a temperature sensor at the inlet to the compressor can cause problems which are associated with the additional cost of using a new sensor, or the lack of space to position it upstream from the compressor.

Moreover, the flow of air which enters the low-pressure turbocharger is equal to the sum of the flow of air measured by the flow meter, and the flow which circulates in the low-pressure recirculation circuit. However, in the case of two stepped turbochargers (low pressure and high pressure), the fact of using a flow meter at the inlet to the HP compressor, or in the recirculation circuit, poses problems similar to those for implementation of a temperature sensor.

An object of the present invention is to improve the regulation of the inlet manifold boost pressure, and thus the control of an engine.

Another object of the invention is to dispense with gas temperature sensors upstream from the compressor, or from the low-pressure compressor if applicable.

In the particular case of stepped turbochargers, another object of the invention is also to dispense with a flow meter upstream from the low-pressure compressor.

For this purpose, according to the invention, a method is provided for controlling an engine which is supercharged by means of a single turbocharger, or by means of an assembly formed by a low-pressure turbocharger and a high-pressure turbocharger, characterized in that:
a temperature of the gases is calculated at the inlet to a compressor of the turbocharger, or at the inlet to the compressor of the low-pressure turbocharger; then
a boost pressure set point is determined, with the set-point value depending in particular on the temperature calculated of the gases at the inlet to the compressor of the turbocharger or at the inlet to the compressor of the low-pressure turbocharger, such as to carry out regulation of the boost pressure in an inlet manifold of the engine.

According to the invention, a device is also provided for controlling an engine which is supercharged by means of a single turbocharger, or by means of an assembly formed by a low-pressure turbocharger and a high-pressure turbocharger, for implementation of the method according to the invention, characterized in that it comprises calculation means which are suitable for calculating a temperature at the inlet to the compressor of the turbocharger or at the inlet to the compressor of the low-pressure turbocharger, and means for determining a boost pressure set point which is dependent on the temperature calculated of the gases at the inlet to the compressor of the turbocharger or at the inlet to the compressor of the low-pressure turbocharger, such as to carry out regulation of a boost pressure in an inlet manifold of the engine.

Other aspects, objects and advantages of the invention will become apparent from reading the following detailed description of preferred embodiments of it, provided by way of non-limiting example, and with reference to the attached drawings, in which:

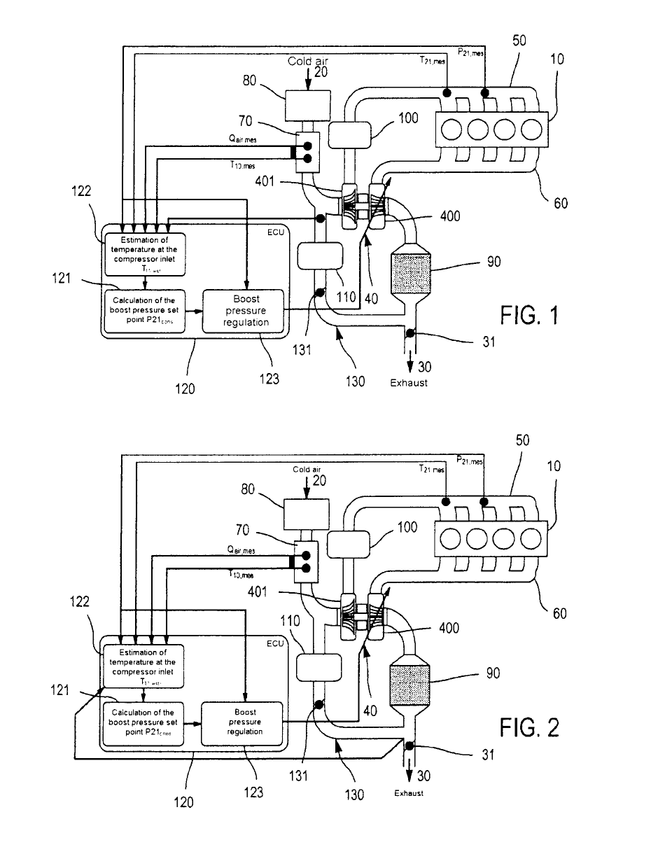

FIG. 1 shows schematically an engine comprising a control system according to a first embodiment of the invention;

FIG. 2 shows schematically an engine comprising a control system according to a second embodiment of the invention;

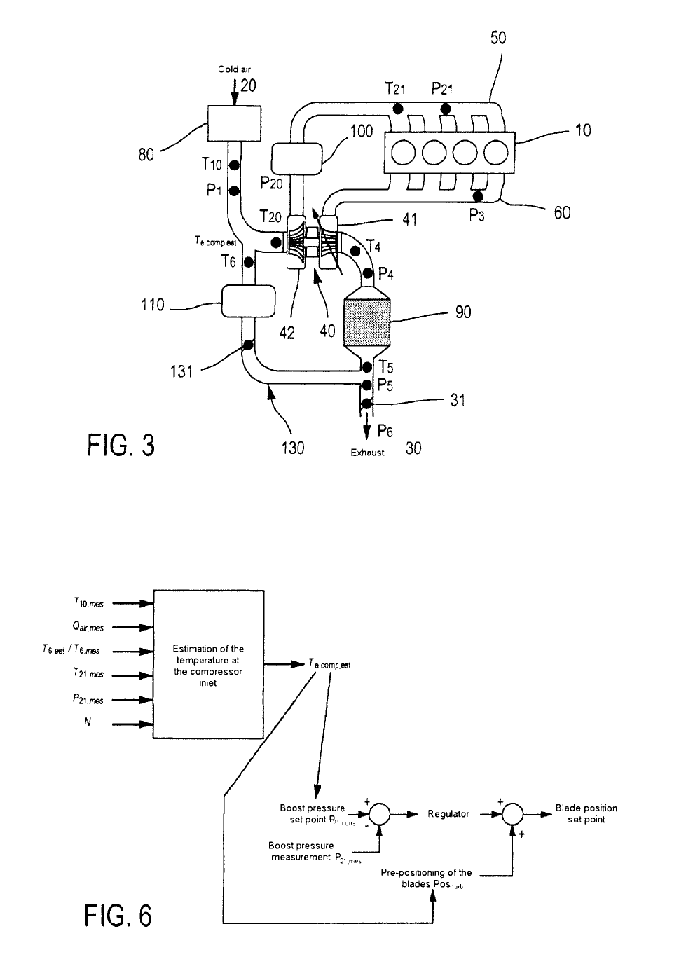

FIG. 3 shows schematically the engine in FIGS. 1 and 2;

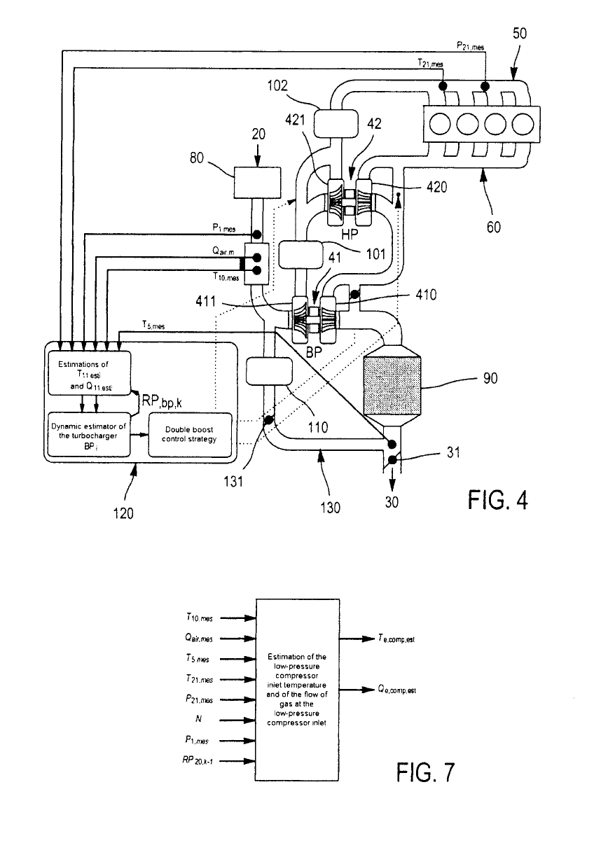

FIG. 4 shows schematically an engine comprising a control system according to a second embodiment of the invention;

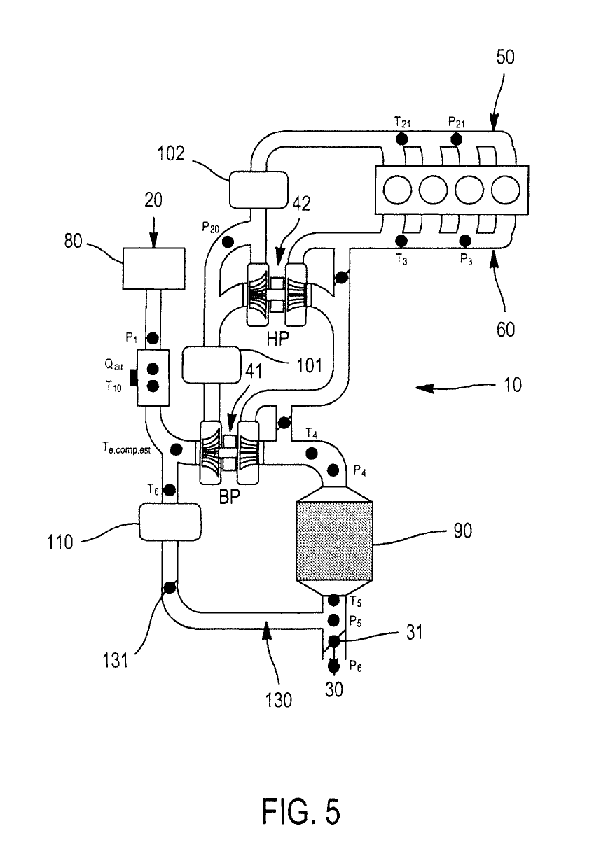

FIG. 5 shows schematically the engine in FIG. 4;

FIG. 6 represents an embodiment according to the invention of a structure for regulation of a boost pressure of a manifold of the engine in FIGS. 1 and 2; and

FIG. 7 represents an embodiment according to the invention of a structure for regulation of a boost pressure of a manifold of the engine in FIG. 3.

With reference to FIGS. 1 to 5, an internal combustion engine 10 of a motor vehicle, of the diesel type, is supplied with cold air via an inlet 20, and discharges the burnt gases via an exhaust 30.

The cold air inlet circuit which ensures the supply of cold air of the engine 10 substantially comprises an air filter 80 and an air flow meter 70, which, by means of a turbocharger 40 or two stepped turbochargers (low pressure 41 and high pressure 42) and appropriate piping, supply the inlet manifold 50 of the engine 10.

An exhaust manifold 60 recuperates the exhaust gases obtained from the combustion, and discharges the latter to the exterior, by means of the turbocharger 40, or if applicable turbochargers 41, 42, and a particle filter which is designed to reduce the quantity of particles, in particular of soot, expelled into the environment.

As far as the turbochargers 40, 41 or 42 are concerned, each comprises substantially a turbine 400, 410, 420, which is driven by the exhaust gases, and a compressor 401, 411, 421 which is fitted on the same axis as the turbine, and ensures compression of the air which is distributed by the air filter 80, for the purpose of increasing the quantity of air admitted into the cylinders of the engine 10 via an exhaust gas recirculation circuit 130.

In this exhaust gas recirculation circuit 130 of low-pressure type, the circuit is outside the supply circuit. It is constituted by putting into communication the exhaust circuit after the particle filter 90 and the inlet circuit before the compressor 401, or if applicable before the low-pressure compressor 411, via a section of passage with dimensions which are regulated by an exhaust gas recirculation valve 131.

The opening of the valve 131 is controlled by a central unit 120, thus making it possible to reintroduce exhaust gases into the inlet circuit.

The exhaust valve 31, for its part, is situated on the exhaust line after the exhaust gas recirculation valve 131, in order to increase the difference in pressure at the edge of the exhaust gas recirculation circuit 130, and therefore the rate of recirculation, so as to reduce the quantities of nitric oxides present.

In addition, a cooler 110 can be placed between the compressor 401, or if applicable the low-pressure compressor 411, and the valve 131, in order to cool the temperature at the inlet to the compressor 401, 411.

The turbocharger 401, 411 is associated with a unit for regulation of the power of the exhaust gases, which is designed to regulate the pressure which exists in the inlet manifold 50 around a boost pressure set-point value P21_{cons}.

A regulation unit of this type can correspond to blades in the case of variable geometry, or to discharge valves in the case of fixed geometry.

In addition, in the case of a single turbocharger 40, an exchanger 100 and an air inlet shutter can be placed between the compressor 42 and the inlet manifold 50, in order to cool the air at the outlet from the compressor 42. In the case of stepped turbochargers 41, 42, a low-pressure exchanger 101 can be provided between the low-pressure compressor 411 and the high-pressure compressor 421, and a high-pressure exchanger 102 can be provided between the high-pressure compressor 421 and the inlet manifold 50.

According to the invention, the central unit 120 recuperates pressure and temperature measurement signals by means of appropriate sensors.

As illustrated in FIG. 1 or 5, advantageously, it can recuperate the boost pressure P21ₘₑₛ and the temperature T21ₘₑₛ in the inlet manifold 50.

It can also receive the pressure at the inlet to, and outlet from the turbine, or if applicable the low-pressure turbine P3ₘₑₛ and P4ₘₑₛ, the pressure at the inlet to, and outlet from the compressor, or if applicable the low-pressure compressor P1ₘₑₛ and P20ₘₑₛ, or the pressure before and after the exhaust valve P5ₘₑₛ and P6ₘₑₛ.

It can also recuperate, for example, the temperature T20ₘₑₛ at the outlet from the compressor, or if applicable the low-pressure compressor, that at the inlet to T3ₘₑₛ, and T4ₘₑₛ outlet from the turbine, or if applicable the low-pressure turbine, and those at the outlet from the air filter T10ₘₑₛ and before the exhaust valve T5ₘₑₛ.

In addition, the central unit 120 comprises means 121 for determination of the boost pressure set point P21_{cons} and means 122 for calculation of a temperature of the gases at the inlet to the compressor Te_{comp,est}. In the case of a single turbocharger, the means 121 of the central unit 120 also make it possible to determine a pre-positioning value of the blades Pos_{turb}.

The measurements, as well as the set points, are supplied to the input of a regulation structure 123 contained in the central unit 120.

This structure 123 comprises one or a plurality of regulators in series.

In a variant embodiment, a single regulator makes it possible to regulate the boost pressure in the inlet manifold 50 to the boost pressure set point P21_{cons}.

More particularly, this regulation structure 123 depends on the value of the temperature of the gases at the inlet to the compressor Te_{comp,est} which is calculated in the central unit 120.

This structure 123 will be described hereinafter with reference to FIG. 4.

According to the invention, the temperature of the gases at the inlet to the compressor Te_{comp,est} is calculated at least by means of the following steps, i.e. calculation of the flow of gas at the inlet to the compressor Qe_{comp,est} and determination of the temperature at the outlet from the cooler T6 of the exhaust gas recirculation system 130.

Preferably, the step of calculation of the flow of gas at the inlet to the compressor Qe_{comp,est} is carried out in accordance with the flow of gas at the inlet to the engine Qmot and with the time of transfer of the gases into the boost circuit tₜᵣₐₙₛ, these two variables having been determined respectively during preliminary steps described below.

The step of determination of the flow of gas at the inlet to the engine Qmot comprises inputs relating to the data concerning the pressures and temperatures as supplied for example by the sensors, as well as one or a plurality of other inputs relating to physical values which are representative for example of the state of the engine.

The following can be cited as inputs:
the boost pressure P21ₘₑₛ;
the temperature in the inlet manifold T21ₘₑₛ;
the constant of the air R;
the engine revolution speed N;
the engine capacity V_{cyl};
the volumetric output of the engine ηᵣ.

The flow of gas at the inlet to the engine Qmot is then defined by means of the following relationship (1):

$$Qmot = \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} ) \qquad ( 1 )$$

It should be noted that the value of the volumetric output of the engine ηᵣ is expressed as a function of the engine speed of the density of the gases admitted, defined as the ratio of the boost pressure P21ₘₑₛ and the product of the constant of the air R to the temperature in the inlet manifold T21ₘₑₛ, as emphasized by the following relationship (2):

$${η}_{r} = ( \frac{P {21}_{mes}}{R \cdot T {21}_{mes}} ) \qquad ( 2 )$$

For an engine comprising a single turbocharger, the step of determination of the time of transfer of the gases into the boost circuit tₜᵣₐₙₛ is carried out by means of the following relationship (3):

$${t}_{trans} = \frac{d}{d t} ( \frac{P {21}_{mes} \cdot {V}_{sural}}{R \cdot T {21}_{mes}} ) \qquad ( 3 )$$

wherein Vₛᵤᵣₐₗ defines the volume of the boost circuit between the outlet from the compressor 401 and the inlet to the engine 10.

On the other hand, for an engine with two stepped turbochargers 41, 42, the step of determination of the time of transfer of the gases into the boost circuit tₜᵣₐₙₛ is carried out by means of the following relationship (3′):

$${t}_{trans} = \frac{d}{d t} ( \frac{P 20 \cdot {V}_{sural , BP}}{R \cdot T {21}_{mes}} ) - \frac{d}{d t} ( \frac{P {21}_{mes} \cdot {V}_{sural , HP}}{R \cdot T {21}_{mes}} ) \qquad ( {3}^{′} )$$

wherein V_{sural,BP} defines the volume of the boost circuit between the outlet from the low-pressure compressor 411 and the inlet to the high-pressure compressor 421, V_{sural,HP} defines the volume of the boost circuit between the outlet from the high-pressure compressor and the engine inlet, and P20 defines the pressure at the inlet to the high-pressure compressor.

The pressure P20 is estimated by the following recurrence relationship:

P_{20,k}=RP_{20,k-1}*P₁ (3″)

wherein R is the low-pressure compression ratio supplied by a dynamic estimator, and k is the index of recurrence of the relationship.

The following step of calculation of the flow of gas at the inlet to the compressor Qe_{comp,est}, or the low-pressure compressor if applicable, is then expressed as the flow of gas at the inlet to the engine Qₘₒₜ, decreased by a derived corrective term expressed by the time of transfer of the gases into the boost circuit tₜᵣₐₙₛ.

In the case of a single turbocharger, the flow of gas at the inlet to the compressor is then expressed as:

$${Qe}_{comp , est} = 3600 \times [ \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} ) - \frac{d}{d t} ( \frac{P {21}_{mes}}{R \cdot T {21}_{mes}} \cdot {V}_{sural} ) ] \qquad ( 4 )$$

In the case of a stepped turbocharger engine (low pressure, high pressure), the flow of gas at the inlet to the low-pressure compressor 411 is then expressed as:

$${Qe}_{comp , est} = 3600 \times [ \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} ) - \frac{d}{d t} ( \frac{{P}_{20}}{R \cdot T {21}_{mes}} \cdot {V}_{sural , BP} ) - \frac{d}{d t} ( \frac{P {21}_{mes}}{R \cdot T {21}_{mes}} \cdot {V}_{sural , HP} ) ] \qquad ( {4}^{′} )$$

With an engine which comprises a plurality of stepped turbochargers, it is therefore necessary to estimate the pressure P20, in order to obtain an estimation of the flow of gas at the inlet to the low-pressure compressor, whereas this estimation is not necessary with a single compressor.

Ultimately, a value of the flow of gas which enters the low-pressure compressor is obtained, whilst dispensing with a flow meter.

In addition, in the following step, the temperature at the outlet from the cooler T6 of the exhaust gas recirculation system 130 can be determined by calculation (T6ₘₑₛ), or it can be measured (T6ₑₛₜ) with appropriate means.

The calculation of the temperature at the outlet from the cooler T6ₑₛₜ of the exhaust gas recirculation system 130 comprises inputs relating to:
the temperature before the exhaust valve T5ₘₑₛ;
the temperature of the cooling water of the cooler of the exhaust gas recirculation system T_{eau,mes};
the efficiency of cooling of the cooler of the exhaust gas recirculation system ε_{egr}_{_{—}}_{bp}.

The temperature at the outlet from the cooler T6ₑₛₜ is then defined according to the following relationship (5):

T6ₑₛₜ=T5−ε_{egr}_{_{—}}_{bp}(T5−T_{eau,mes}) (5)

It should be noted that the variable which defines the efficiency of cooling of the cooler of the exhaust gas recirculation system ε_{egr}_{_{—}}_{bp} is a function which depends on a plurality of parameters, and advantageously on the variable Qegr alone, which is the flow which circulates in the recirculation circuit, the latter being defined by the relationship:

Q_{EGR}=Qe_{comp,est}−Q_{air,frais} (5′)

After having determined the flow of gas at the inlet to the compressor Qe_{comp,est} and the temperature at the outlet from the cooler T6 of the exhaust gas recirculation system 130, there is deduced in the following step, by calculation, therefrom the temperature of the gases at the inlet to the compressor Te_{comp,est} as shown by the relationship (6) below:

$${Te}_{comp , est} = \frac{\begin{matrix}Cpech \cdot {Qe}_{comp , est} \cdot T 6 + \\ Cpair \cdot Qair \cdot T {10}_{mes} - Cpech \cdot Qair \cdot T 6\end{matrix}}{( Cpair - Cpech ) \cdot Qair + Cpech \cdot {Qe}_{comp , est}} \qquad ( 6 )$$

This is also defined with inputs relating to:
the specific heat of the air Cpair;
the specific heat of the exhaust gases Cpech;
the flow of cold air estimated Qair;
the temperature at the outlet from the air filter T10ₘₑₛ.

It should be noted that the specific heat of the air Cpair at the inlet is preferably determined in accordance with the temperature at the outlet from the air filter T10ₘₑₛ of the exhaust gas recirculation system 130.

The specific heat of the exhaust gases Cpech, for its part, is preferably determined in accordance with the temperature before the exhaust valve T5ₘₑₛ and a variable Rᵢ_{_{—}}_{ech} defined as the product of the ratio of the mass flow of fuel and the mass flow of air, with a stoichiometric coefficient Ks with a value of 14.8, as emphasized by the relationship (7) below:

$${R}_{i\_ech} = {K}_{s} \frac{\dot{Q} carb}{\dot{Q} air} \qquad ( 7 )$$

In this step, a temperature value of the gases at the inlet to the compressor Te_{comp,est} is thus obtained, whilst dispensing with a temperature sensor in the cold air circuit.

This is therefore calculated directly from the characteristics of the engine and measurements or estimations of the following values which exist:
the temperature at the outlet from the air filter T10ₘₑₛ;
the flow of cold air measured Qair,mes;
the temperature of the inlet manifold T21ₘₑₛ;
the boost pressure P21ₘₑₛ;
the temperature at the outlet from the cooler measured T6ₘₑₛ or calculated T6ₑₛₜ according to the embodiment selected.

The system for controlling the engine which regulates the boost pressure thus has robustness in relation to the data relating to the temperature Te_{comp,est} of the gases at the inlet to the compressor, or if applicable the low-pressure compressor.

In fact, the calculation of the temperature Te_{comp,est} of the gases at the inlet to the compressor, or if applicable the low-pressure compressor, makes it possible to dispense with measurement errors associated with the lack of homogeneousness of the temperature mixture upstream from the compressor, constituted by the temperature at the outlet from the gas recirculation circuit and the temperature of cold air at the air filter outlet.

In the central unit 120 comprising the aforementioned regulator, the boost pressure regulator receives as input the difference between a boost pressure set point P21_{cons} which is dependent on the temperature of the gases at the inlet to the compressor Te_{comp,est} calculated, and on the measurement of the boost pressure P21ₘₑₛ recuperated by the central unit 120.

The correction decreases the boost pressure set point P21_{cons} in order to limit the speed of the turbocharger, and thus protects the turbochargers against excess speeds and high temperatures.

In the case of a single turbocharger with variable geometry, the output of the regulator is then added to the result of the calculation of a pre-positioning value of the blades Pos_{turb}, in order to obtain a position set point for the blades. The result obtained in the calculation of the temperature of the gases at the inlet to the compressor Te_{comp,est} is also used as an input variable in the calculation of this value of pre-positioning of the blades Pos_{turb}. The pre-positioning is thus corrected in accordance with the temperature of the cold air which enters the compressor. The position set point of the blades thus makes it possible to supply at the output of the central unit 120 a control signal which controls the unit for regulation of the power of the exhaust gases, and more specifically the blades, in order to regulate the pressure which exists in the inlet manifold 50 around the set-point boost pressure value P21_{cons} and act on the pressure of the engine exhaust gases.

1-12. (canceled)

13. A method for controlling an engine supercharged by a single turbocharger, or by an assembly formed by a low-pressure turbocharger and a high-pressure turbocharger, the method comprising:
calculating a temperature Te_{comp,est} of gases at an inlet to a compressor of the turbocharger, or at an inlet to the compressor of the low-pressure turbocharger; then determining a boost pressure set point P21_{cons}, with the set-point value depending on the temperature calculated Te_{comp,est} of the gases at the inlet to the compressor of the turbocharger or at the inlet to the compressor of the low-pressure turbocharger, such as to carry out regulation of the boost pressure in an inlet manifold of the engine.

14. The method as claimed in claim 13, wherein the temperature Te_{comp,est} of the gases at the inlet to the compressor or at the inlet to the low-pressure compressor is calculated by the following relationship:
$${Te}_{comp , est} = \frac{\begin{matrix}Cpech \cdot {Qe}_{comp , est} \cdot T 6 + \\ Cpair \cdot Qair \cdot T {10}_{mes} - Cpech \cdot Qair \cdot T 6\end{matrix}}{( Cpair - Cpech ) \cdot Qair + Cpech \cdot {Qe}_{comp , est}}$$
wherein:
Qe_{comp,est} defines a flow of gas at the inlet to the compressor;
Cpair defines the specific heat of the air;
Cpech defines the specific heat of the exhaust gases;
Qair defines a flow of cold air;
T10ₘₑₛ defines a temperature at the outlet from an air filter;
T6 defines a temperature at the outlet from a cooler of an exhaust gas recirculation system.

15. The method as claimed in claim 14, further comprising calculation of flow of gas Qe_{comp,est} at the inlet to the compressor or to the low-pressure compressor.

16. The method as claimed in claim 15, wherein the calculation of the flow of gas at the inlet to the compressor Qe_{comp,est} depends on the flow of gas at the inlet to the engine Qmot and on the time of transfer tₜᵣₐₙₛ into a boost circuit of the engine.

17. The method as claimed in claim 16, wherein, with the engine comprising a single turbocharger, the flow of gas at the inlet to the compressor is calculated by relationship:
$${Qe}_{comp , est} = 3600 \times [ \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} ) - \frac{d}{d t} ( \frac{P {21}_{mes}}{R \cdot T {21}_{mes}} \cdot {V}_{sural} ) ]$$
$$with$$
$$Qmot = \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} ) and \\ {t}_{trans} = \frac{d}{d t} ( \frac{P {21}_{mes} \cdot {V}_{sural}}{R \cdot T {21}_{mes}} )$$
and
P21ₘₑₛ is the boost pressure;
T21ₘₑₛ is the temperature in the inlet manifold;
R is the constant of the air;
N is the engine revolution speed;
V_{cyl} is the engine capacity;
ηᵣ is the volumetric output of the engine;
Vₛᵤᵣₐₗ is the volume of the boost circuit between the outlet from the compressor and the inlet to the engine.

18. The method as claimed in claim 16, wherein, with the engine comprising an assembly formed by a low-pressure turbocharger and a high-pressure turbocharger, the flow of gas at the inlet to the compressor of the low-pressure turbocharger is calculated by relationship:
$${Qe}_{comp , est} = 3600 \times [ \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} ) - \frac{d}{d t} ( \frac{{P}_{20}}{R \cdot T {21}_{mes}} \cdot {V}_{sural , BP} ) - \frac{d}{d t} ( \frac{P {21}_{mes}}{R \cdot T {21}_{mes}} \cdot {V}_{sural , HP} ) ]$$
$$with$$
$$Qmot = \frac{P {21}_{mes}}{R \cdot T {21}_{mes}} \times \frac{{V}_{cycl} \cdot N}{2 \cdot 60} {η}_{r} ( N , \frac{P {21}_{mes}}{R \cdot T {21}_{mes}} )$$
$$and$$
$${t}_{trans} = \frac{d}{d t} ( \frac{P 20 \cdot {V}_{sural , BP}}{R \cdot T {21}_{mes}} ) - \frac{d}{d t} ( \frac{P {21}_{mes} \cdot {V}_{sural , HP}}{R \cdot T {21}_{mes}} )$$
$$and$$
P21ₘₑₛ is the boost pressure;
T21ₘₑₛ is the temperature in the inlet manifold;
R is the constant of the air;
N is the engine revolution speed;
V_{cyl} is the engine capacity;
ηᵣ is the volumetric output of the engine;
V_{sural,BP} defines the volume of the boost circuit between the outlet from the low-pressure compressor and the inlet to the high-pressure compressor;
V_{sural,HP} defines the volume of the boost circuit between the outlet from the high-pressure compressor and the engine inlet; and
P20 is the pressure at the inlet to the high-pressure compressor.

19. The method as claimed in claim 18, wherein the pressure P20 at the inlet to the high-pressure compressor is estimated by recurrence relationship:
P_{20,k}=RP_{20,k-1}*P_{20,1}
with k as the index of recurrence, P1 as the first estimated value of the pressure at the inlet to the high-pressure compressor, and R as the low-pressure compression ratio supplied by a dynamic estimator.

20. The method as claimed in claim 14, further comprising calculation of the temperature at the outlet from the cooler T6 of the exhaust gas recirculation system.

21. The method as claimed in claim 20, wherein the calculation of the temperature at the outlet from the cooler T6 of the exhaust gas recirculation system is defined by following relationship:
T6=T5−δ_{egr}_{_{—}}_{bp}(T5−T_{eau,mes})
where:
T5 defines a temperature before an exhaust valve;
T_{eau,mes} defines a temperature of the cooling water of the cooler of the exhaust gas recirculation system;
ε_{egr}_{_{—}}_{bp} defines the efficiency of cooling of the cooler of the exhaust gas recirculation system.

22. The method as claimed in claim 13, wherein a pre-positioning variable of a unit for regulation of the power of the exhaust gases Pos_{turb} is determined, with the value of the variable depending on the temperature calculated of the gases at the inlet to the compressor Te_{comp,est}.

23. The method as claimed in claim 13, wherein a control signal is supplied to control the unit for regulation of power of the exhaust gases, with the value of the signal depending on pre-positioning variable Pos_{turb}.

24. A device for controlling an engine which is supercharged by a single turbocharger, or by an assembly formed by a low-pressure turbocharger and a high-pressure turbocharger, for implementation of the method as claimed in claim 13, comprising:
calculation means for calculating a temperature Te_{comp,est} at the inlet to the compressor of the turbocharger or at the inlet to the compressor of the low-pressure turbocharger; and
means for determining a boost pressure set point P21_{cons} which is dependent on the temperature calculated Te_{comp,est} of the gases at the inlet to the compressor of the turbocharger or at the inlet to the compressor of the low-pressure turbocharger, such as to carry out regulation of a boost pressure in an inlet manifold of the engine.
